(19) United States
(12) Patent Application Publication
(10) Pub. No.: US 2008/0244655 A1
(43) Pub. Date: Oct. 2, 2008

(54) VIRAL MARKETING OF BROADCAST CONTENT

(75) Inventors: Ville-Veikko Mattila, Tampere (FI); Riku Suomela, Tampere (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/692,621

(22) Filed: Mar. 28, 2007

(51) Int. Cl. H04N 5/445

(52) U.S. Cl. 725/46

(57) ABSTRACT

Viral marketing may be used in the delivery of broadcast content over networks such as DVB-H networks. By tracking and monitoring viewer recommendations and viewer responses to recommendations, content providers may target viewers and/or peer groups for marketing various types of content. Content may include advertisements, television programs, service announcements and the like. Feedback from viewers may be received on a user device through a backward or upstream channel. The viewers may be provided with a recommendation interface. In one or more configurations, the interface may be integrated into an electronic programming guide.

### BACKGROUND

Channel surfing has become a normal activity as viewers attempt to find programming content that suits their tastes. Oftentimes, content providers such as television stations will provide a content line-up that includes a variety of content to suit everyone's tastes. In addition, this content may be placed in time slots that specifically target certain demographics. Further, some content providers may attempt to market new content by scheduling the new content strategically (e.g., between two popular programs). However, this content placement decisioning process is typically based on highly generalized data regarding when viewers are watching television or accessing content and their characteristics (age, gender, occupation). As such, content providers might not be maximizing their viewership (and their marketing potential for new content) by scheduling content based on general demographic evaluations. Since advertising and marketing (e.g., in the form of commercials) are often tied to certain programming content, the ability of advertisers to maximize their results may suffer from similar deficiencies.

In view of the foregoing, methods and systems for content selection and scheduling based on viewer feedback are needed.

### SUMMARY

Aspects of content selection and scheduling based on viewer feedback provide a system and method for viewers to enter their recommendations and/or comments regarding a program through a user device. For example, viewers may enter their comments through an electronic program guide feature on their viewing device. The feedback may be collected at a recommendation service associated with a content provider and the feedback data may be subsequently analyzed. The analysis of the feedback data may provide information regarding the demographic that is submitting positive recommendations. For example, the analysis may produce information relating to the strength of a particular viewer's recommendations and/or peer groups with which the recommending viewer's are associated. Each of these factors may play a role in a content provider's decision in what content to schedule and how to schedule that content. In addition, a content provider may also use the information to determine which viewers to target in marketing particular programming content. Further, this information may be used by advertisers and other companies to determine which channels and/or programs would be the best match for certain advertisements.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a mobile terminal on which one or more aspects described herein may be implemented.

FIG. 2 illustrates a network environment in which one or more aspects described herein may be implemented.

FIG. 3 is a flowchart illustrating a method for identifying popular or desired programs based on viewer feedback according to one or more aspects described herein.

FIGS. 4A and 4B are diagrams illustrating user interfaces for providing feedback options to users according to one or more aspects described herein.

FIG. 5 illustrates a user interface for a viewer to view recommendations made according to one or more aspects described herein.

FIG. 6 is a flowchart illustrating a method for determining a content schedule based on viewer feedback according to one or more aspects described herein.

FIG. 7 illustrates a recommendation graph for determining recommendation distribution and the strength of various viewers' recommendations according to one or more aspects described herein.

FIG. 8 is a diagram of a system for collecting, processing and managing recommendation data according to one or more aspects described herein.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

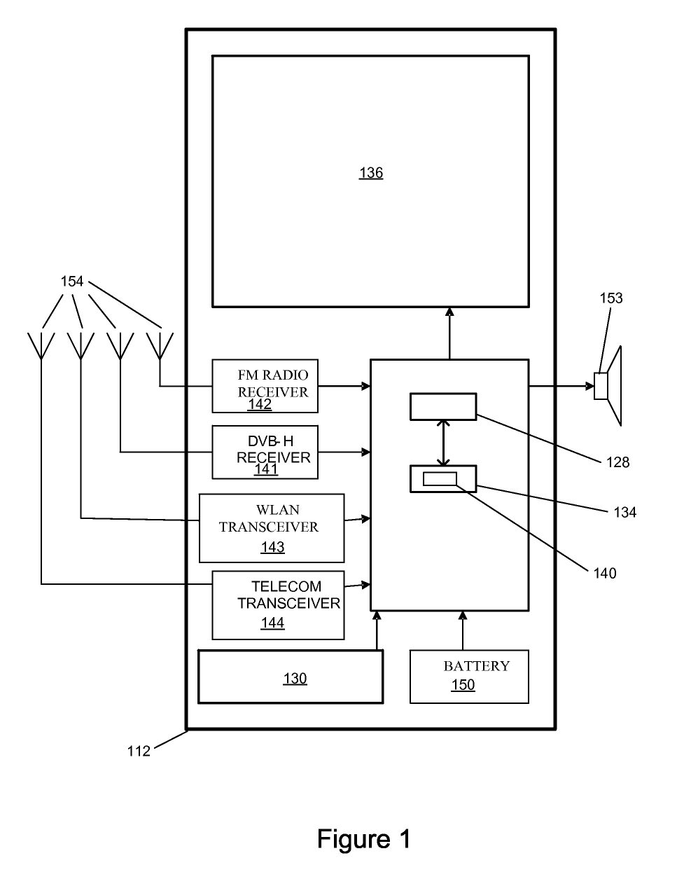

FIG. 1 illustrates a block diagram of a terminal including processor 128 connected to user interface 130, memory 134 and/or other storage, and display 136. Mobile terminal 112 may also include battery 150, speaker(s) 153 and antennas 154. User interface 130 may further include a keypad, touch screen, voice interface, one or more arrow keys, joy-stick, data glove, mouse, roller ball, touch screen, or the like. Mobile terminal 112 may comprise a computer, personal data assistant (PDA), mobile telephone and the like.

Computer executable instructions and data used by processor 128 and other components within mobile terminal 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile terminal 112 to perform various functions. Alternatively, some or all of mobile device 112 computer executable instructions may be embodied in hardware or firmware (not shown).

Mobile terminal 112 may be configured to receive, decode and process digital radio or television broadcast transmissions that are based, for example, on the DVB (Digital Video Broadcasting) standards, through a specific DVB receiver 141. The mobile device may also be provided with other types of receivers for digital broadcast transmissions, such as MediaFLO, DMB (Digital Multimedia Broadcasting), ISDB (Integrated Services Digital Broadcasting), HDTV (High-definition television), DAM (Digital Audio Broadcasting), DRM (Digital Radio Mondiale), etc. Additionally, mobile terminal 112 may also be configured to receive, decode and process transmissions through FM/AM Radio receiver 142, WLAN transceiver 143, and wireless telecommunications transceiver 144. Transceivers 143 and 144 may, alternatively, be separated into individual transmitter and receiver components (not shown). In one example, transceiver 144 may include a broadcast receiver (not shown) and a backward channel receiver (not shown) for communicating over the broadcast channel and the backward channel, respectively. In one aspect of the invention, mobile terminal 112 may receive Radio Data System (RDS) messages. Other transmission and reception systems may also be used including Bluetooth, WiMAX (Worldwide Interoperability for Microwave Access) i.e. IEEE 802.16 standard, and/or UWB (Ultra-wideband) transceivers. In one or more instances, signals may be transmitted to and received from another mobile terminal (not shown). For example, audio, video and other signals may be transmitted between two terminals using various transmissions protocols such as wireless local area networks (WLANs), General Packet Radio Service (GPRS), third generation mobile system technology (3G), Bluetooth and/or Universal Plug and Play (UPnP). Such networks may be used to access or support local networks or remote networks such as the Internet.

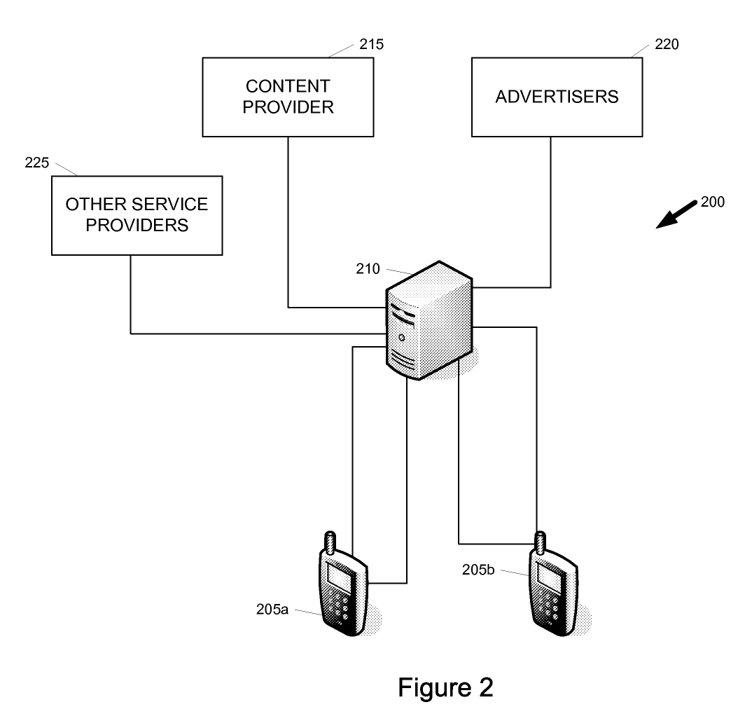

FIG. 2 illustrates a block diagram of a broadcast network environment in which one or more aspects described herein may be implemented. Network 200 includes user devices 205a and 205b, content server 210, content provider 215, advertisers 220 and other service providers 225. Content server 210, content provider 215, advertisers 220 and other service providers 225 may be located in a same entity, in same system or in same device. The user devices 205a and 205b may include mobile telephones (e.g., mobile terminal 112 of FIG. 1), personal computers (PCs), personal data assistants (PDAs), mobile communication devices, mobile televisions, set-top boxes (STB), audio/video players, digital cameras/camcorders, positioning devices (such as a GPS devices), digital/analog radio receivers, and combinations thereof. Devices 205a and 205b may have the capability and be configured to receive broadcasts from content server 210. In one or more arrangements, devices 205a and 205b may receive multimedia DVB-Handheld (H) broadcasts such as television programming from server 210. The content distributed by server 210 may originate from server 210 or a service associated with server 210 or, alternatively or additionally, from content provider 215.

Content provider 215 may include media companies, content stores that have licensed particular content for distribution and/or individuals who may produce their own work. In one example, content provider 215 may provide movies to server 210 for distribution to a subscribing device like device 205a over a broadcast network. Content provider 215 may provide programming over a single programming channel or multiple channels. For example, content provider 215 may provide different genres of programming in each of the multiple channels. In addition to content provider 215, content distributed to devices 205a and 205b may also be received from advertisers 220. Advertisers 220 may produce commercials or other types of advertisements for broadcasting during the broadcast of other content such as television programs or movies. In one or more configurations, commercials may already be apart of content provided by content provider 215.

As described, network 200 may further include other service providers 225. Other service providers 225 may provide various services for server 210. In one example, an electronic program guide (EPG) service provider included in providers 225 may aid server 210 in the generation of EPGs and in communicating the EPG to other services in server 210. Other services and content may include electronic service guide (ESG) and interactive program guide (IPG). In another example, service providers 225 may process on-demand requests received by server 210 from subscribing devices 205a and 205b. In still another example, a recommendation service of service providers 225 may be configured to process recommendation information received from devices 205a and 205b. Recommendations may relate to preferred content items, preferred content channels, preferred types of services and the like. Accordingly, a recommendation service may collect, maintain and evaluate such information to modify and improve content offerings and as a vehicle to improve marketing (as is discussed in further detail below).

Network 200 may facilitate communications between devices 205, server 210, content provider 215, advertisers 220 and service providers 225 using a variety of protocols. For example, devices 205 may interact with server 210 using DVB-H broadcast protocol while server 210 may communicate with advertisers 220, service providers 225 and content provider 215 using Internet protocol (IP). For example, DVB-H broadcast networks may include multiple channels for transmissions to and from devices 205a and 205b. EPGs and programming content may be broadcast to devices 205a and 205b over a first channel while data such as feedback or content requests may be transmitted back to server 210 over a second channel, i.e. a back or backward channel. Devices 205a and 205b may include a backward channel receiver for communicating over the backward channel. The channels may differ in bandwidth based on the amount of information transmitted to a device versus the amount of information transmitted from the device. Accordingly, in one or more instances, a downstream channel (channel for broadcasting information to subscribing devices 205a and 205b) may have greater bandwidth than a backward channel (for receiving information from devices 205a and 205b).

According to one or more aspects, a backward channel in broadcast network 200 may be used to receive feedback from subscribers relating to their likes and dislikes of programming content. In one or more configurations, the backward channel may a separate channel from the broadcast channel. A recommendation service, e.g., of service providers 225, may be used to collect the feedback, analyze trends and determine what programming content is most desirable to certain demographics of peer groups. Peer groups, as used herein, refers generally to a group of subscribers having a common characteristic or attribute. A peer group may be defined as all subscribers that are employed in the financial industry or, alternatively or additionally, as those subscribers that own a pet, or users that have subscribed or signed up for the same service. The peer groups may identify members based on member identifiers or identifiers associated with the devices of the members. The raw data and the processed information may be valuable for a content provider to determine a channel or content lineup to maximize viewership. Since content providers often generate revenue from advertising, maximizing viewership may also aid in maximizing revenue. In addition, the raw data and/or the processed information may help a content provider market new programming to maximize the potential for viewers to watch the new programming.

Further, advertisers and marketers may also use such information to identify programs with which to associate advertisements. For example, tracking viewer behavior and preferences may allow advertisers to better target their audience. In one example, an advertiser may request advertisements to be aired or otherwise broadcast during a specific program that has been identified as highly desirable by a particular peer group. In another example, an advertiser may request that advertisements be placed during a program that has been positively recommended by a viewer who's opinion is particularly strong (e.g., many other viewers follow his or her opinion).

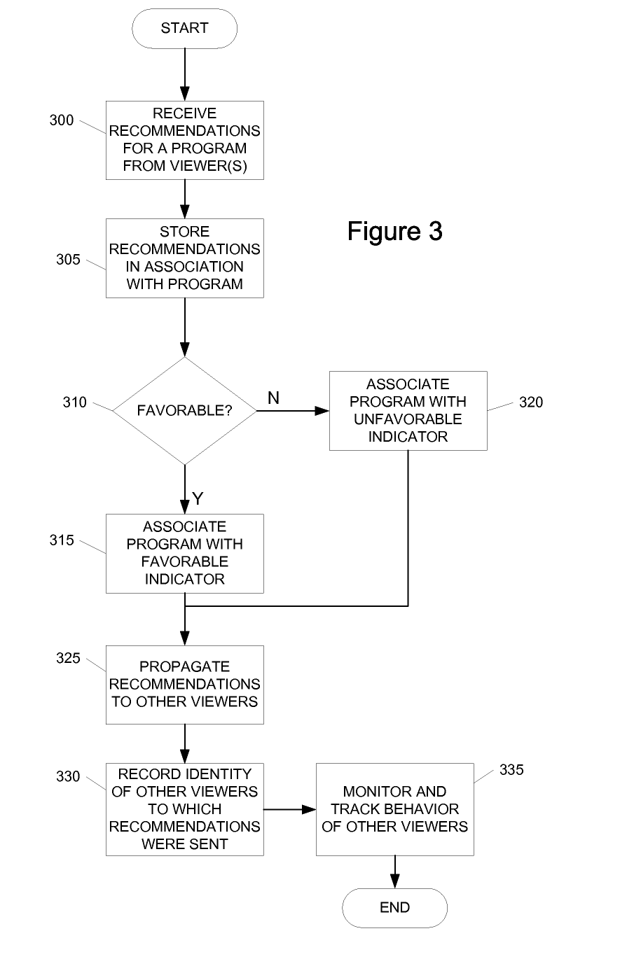

FIG. 3 is a flowchart illustrating a method for determining popular programming based on viewer feedback. In step 300, a recommendation service may receive recommendations for a program from one or more viewers through, e.g., one or more user devices. The recommendations may include various information including whether the viewer enjoyed the program, viewer profile information, viewer comments and the like. The recommendations may be received before, during or after a particular program has been viewed. For example, a viewer may choose to comment on a program only after he or she has finished watching the entire program. In another example, a viewer may already have formed an opinion after the first half hour and thus, may provide a recommendation during the program.

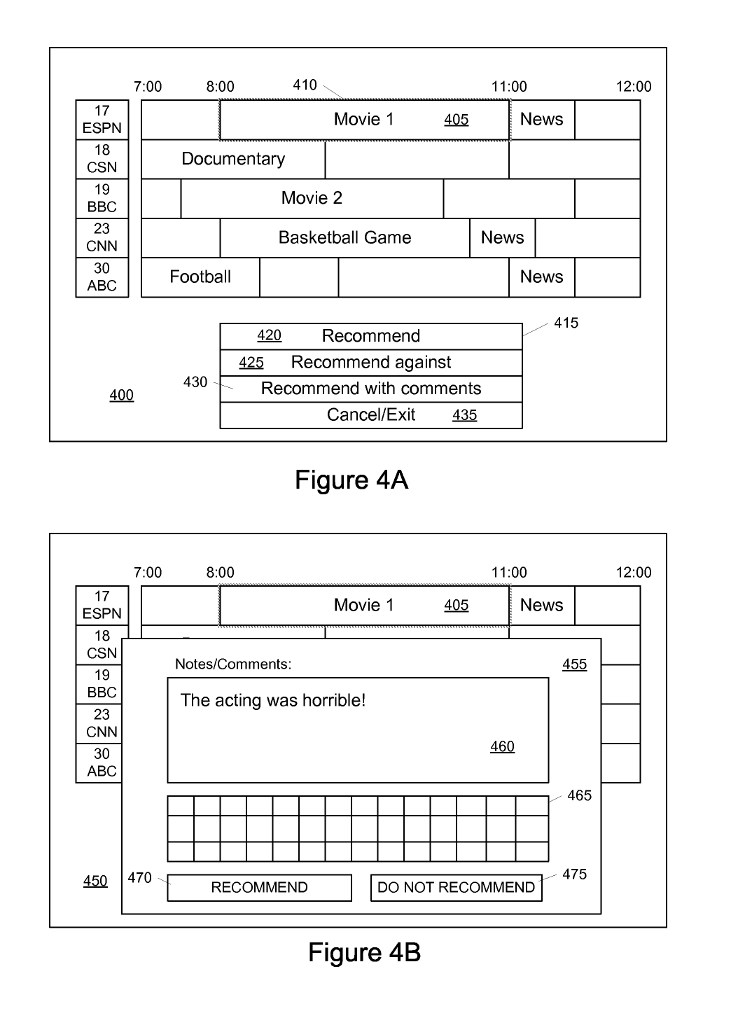

FIGS. 4A and 4B illustrate user interfaces for allowing a viewer to enter recommendation information. In FIG. 4A, for example, a viewer may enter recommendations through an EPG interface (e.g., interface 400) displayed on his or her device. The viewer may navigate to program 405 for which the viewer wishes to provide a recommendation and select a recommendation option (not shown). Selection frame 410 may be used to highlight and indicate the element of interface 400 on which focus is currently centered. Once focused on program 405, the viewer may access a menu using a remote control, a function button on the content receiving device, on interface 400 or combinations thereof. For example, in one instance, a viewer may select an option button on a remote to reveal option menu 415 having features and options available for program 405. Option menu 415 may include a variety of interactions including recommend program 420, recommend against program 425, recommend with comments 430 and cancel 435. Choosing either recommend program 420 or recommend against program 425 may send a predefined message to a recommendation service indicating whether the viewer recommended the program. The viewer may also choose to add free form comments to his or her recommendation by selecting the recommend with comments option 430. For example, the viewer may indicate what particular aspect of a program made the viewer recommend against the program (e.g., “the ending made no sense”). If the viewer does not wish to make a recommendation or wishes to exit the menu, he or she may select cancel option 435.

FIG. 4B illustrates user interface 450 that may be displayed in response to a viewer choosing to make a recommendation with comments (e.g., option 430 of FIG. 4a). Interface 450 may include dialog box 455 overlaying the rest of interface 450. In one or more arrangements, dialog box 455 may be displayed in a different manner than the rest of interface 450 to indicate that dialog box 455 is the active portion of interface 450. For example, dialog box 455 may appear at normal brightness while the rest of interface 450 is displayed as a darker or grayed out area. Dialog box 455 may include notes section 460, keypad 465 and recommendation options 470 and 475. The keypad 465 may be used by the viewer to enter his or her comments into notes section 460. Once the viewer has finished entering his or her comments, the viewer may then select either recommend option 470 or recommend against option 475. Upon completion of the recommendation, interface 450 may return to an EPG or current programming content.

Referring again to FIG. 3, upon receiving one or more recommendations for a program, the recommendations may be stored in association with the program in step 305. The recommendation may also be stored with an identification of the viewer or viewers that made the recommendations. The recommendation may, additionally or alternatively, be stored with an identification of a user device of the user or viewer submitting the recommendation. In step 310, the recommendation service may determine whether the program reviews were favorable. This determination may be made by tabulating the number of positive and the number of negative recommendations and comparing the number or amount of favorable opinions against a threshold value. If the recommendations are determined to be favorable, the program may be associated with a recommended indicator in step 315. If, however, the recommendation service determines that the program reviews were unfavorable, the program may be associated with a negative indicator in step 320. In either situation, the recommendations associated with the program may be propagated to other viewers (or their devices) for their reference in step 325. The program may also, in one or more instances, be transmitted to the devices of the other viewers along with the recommendations. In step 330, the recommendation service may record the viewers and/or the user devices to which the recommendations were sent. The service may then monitor and track which viewers followed the recommendation and which did not in step 335. By doing so, the service may determine viewer behaviors and the strength of recommendations made by particular viewers. For example, if the service notices that 75% of other viewers to which a particular viewer recommended a program end up watching the program, the service may identify the viewer as having strong recommendations.

In one or more arrangements, a recommendation might only be distributed to the devices of other viewers in a peer group common to the viewer or the user device providing the recommendation. Peer groups may be predefined or may be determined based on common characteristics or interests between viewers or user devices. In one example, a peer group may be defined for a group of self-identified friends. In another example, a peer group may be defined for all viewers or user devices having one or more common features (i.e. metadata), such as living in a certain location and/or within the same age range. In yet another example, a peer group may be defined for the players of an on-line multiplayer game, that is, for people who share the same interest for a game but who do not necessarily know each other in real-life. By limiting the distribution of recommendations, a recommendation service may guard viewers against unsolicited or unwanted recommendations in which they might not be interested. According to one or more aspects, a viewer making a recommendation may designate the peer group(s) and/or particular viewers to which he or she wishes to send the recommendation. A recommendation service may gather further information about a viewer's peer group based on the other viewers to which the viewer send the recommendation.

Alternatively or additionally, recommendations might only be distributed if a threshold number or amount of positive recommendations are received. Thus, if over 50% of the recommendations are negative, the recommendations might not be distributed to other viewers. On the other hand, if over 50% of the recommendations are positive, the recommendation may be distributed. In one or more arrangements, recommendations might only be distributed if a threshold number of recommendations are received, regardless of whether they are positive or negative.

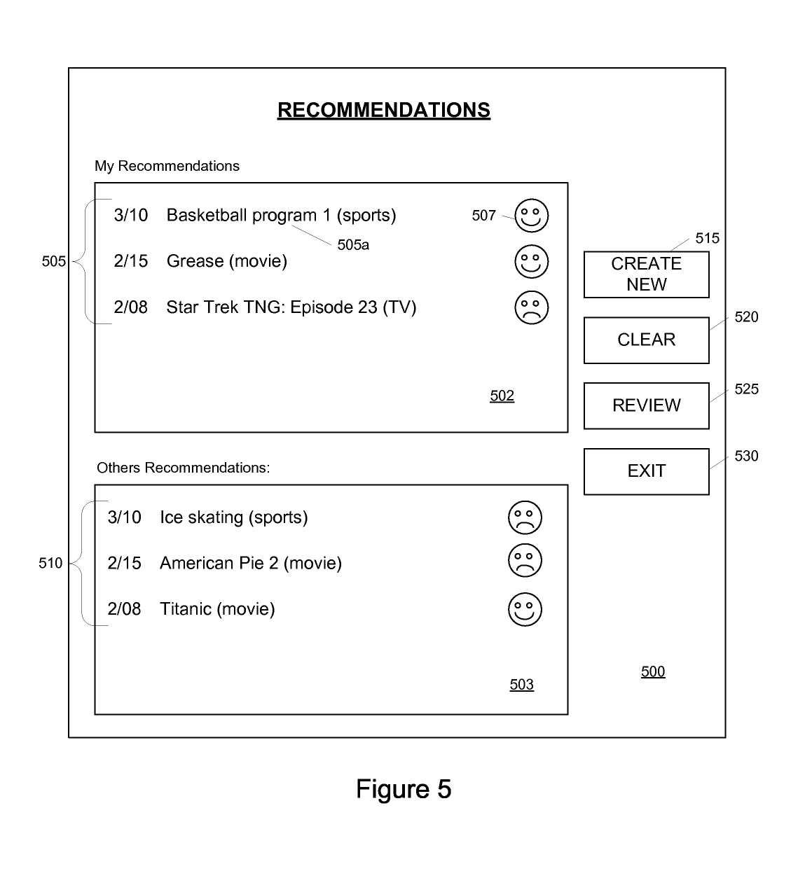

Upon receiving or making a recommendation, a viewer may access and view the recommendation through an EPG, or some other interactive menu 500, or some separate view/window (not shown). FIG. 5 illustrates a user interface displaying recommendations made by 505 and received by 510 a viewer. Region 502 of interface 500 may be dedicated specifically to recommendations 505 made by the viewer while region 503 may be dedicated to recommendation 510 made by other viewers but received by the viewer. Recommendations 505 and 510 may further be ordered by positive recommendations and negative recommendations. Further, each recommendation, e.g., recommendation 505a may include indicator 507 designed to provide a quick indication as to whether a program was recommended or not, possibly with actual viewer comments. Interface 500 may include interactive options such as create recommendation option 515, clear recommendations option 520, review recommendation option 525 and exit option 530. For example, review recommendation option 525, upon selection, may display comments or further details regarding a selected recommendation. A variety of other information and options may be provided in interface 500 based on the functionality provided by the recommendation service and the preferences of a viewer.

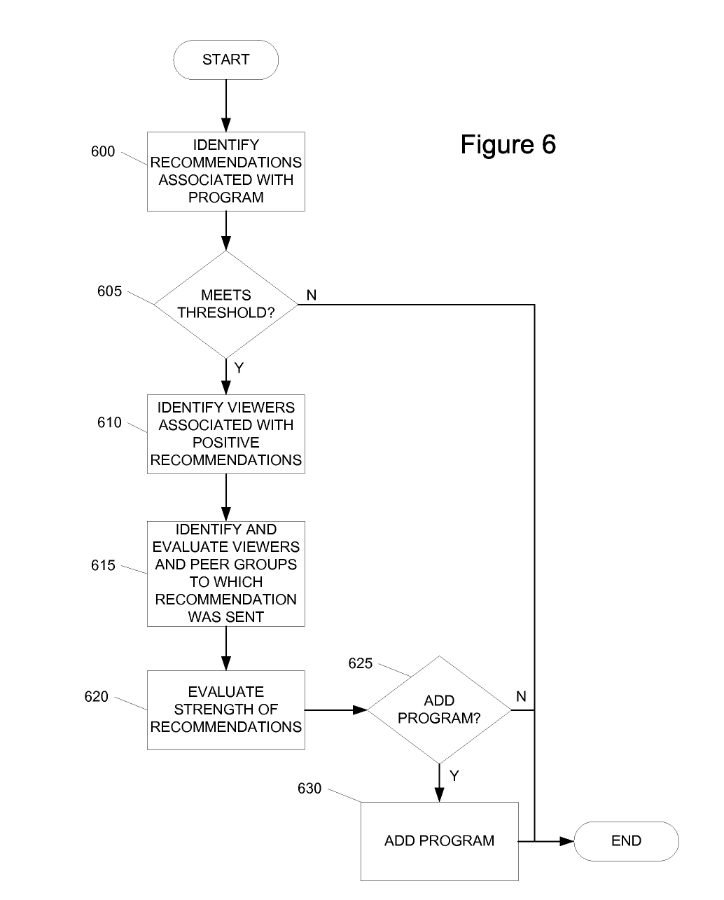

FIG. 6 is a flowchart illustrating a method for determining a content or channel lineup based on viewer recommendations. In step 600, content provider or recommendation service may identify recommendations associated with a program. In step 605, the content server or recommendation service may then determine whether a program has a threshold number of recommendations. If the number recommendations do not meet the threshold, the recommendation service might not consider adding the program to a channel lineup or to a free program slot. In one or more arrangements, the content provider or recommendation service may further evaluate the number of positive or negative recommendations associated with the program. For example, a program may be required to have a threshold number of positive recommendations before being even considered for addition to a content lineup. In another example, a program may be rejected based on a high number of negative recommendations.

If the number of recommendations associated with the program meets or exceeds the threshold, the advertiser or recommendation service may identify the viewers who made the positive recommendations in step 610. The viewers may be identified using an identifier stored in association with each recommendation. The identifier may be a viewer or user identifier or may be a user device identifier. In step 615, information regarding the peer groups and/or viewers to which the recommendations were sent may be evaluated. Such information may be important if a particular content provider is targeted for a particular demographic. For example, a channel or content provider targeted for 18-25 year olds might not be concerned with the viewing trends and preferences of 35-50 year olds.

In addition, information regarding the strength of a viewer's recommendation may be analyzed in step 620. As discussed, the strength of a viewer's recommendation may be determined based on a number or percentage of other viewers who have historically followed the viewer's recommendation. The recommendation strength of viewers may be used to determine whether relying on a particular viewer's recommendation is likely to yield higher viewership among other viewers in the viewer's peer group. In one or more configurations, the characteristics of other viewers who have followed the viewer's recommendation may also be analyzed (e.g., compare the attributes of those viewers who followed the recommendations versus the attributes of those who did not). In step 625, a decision may be made as to whether to place the program in a content or program lineup based on the aforementioned factors. For example, if the recommendation strength of the viewers who provided positive recommendations is low, a content provider might not add or may remove the program from a content lineup. In contrast, if the recommendation strength is high, the content provider may decide to add or keep the program in the content lineup in step 630.

The above described methods may also be used to aid an advertiser in identifying programs in which to advertise. The recommendation information and analyses may be valuable data that may be sold or licensed to advertisers for their own use. For example, an advertiser may evaluate the peer groups to which a program is positively recommended to determine whether to place an advertisement in the program. If the advertisement is targeted for viewers living on the west coast, the advertiser might not want to go to the expense of advertising to an east coast peer group.

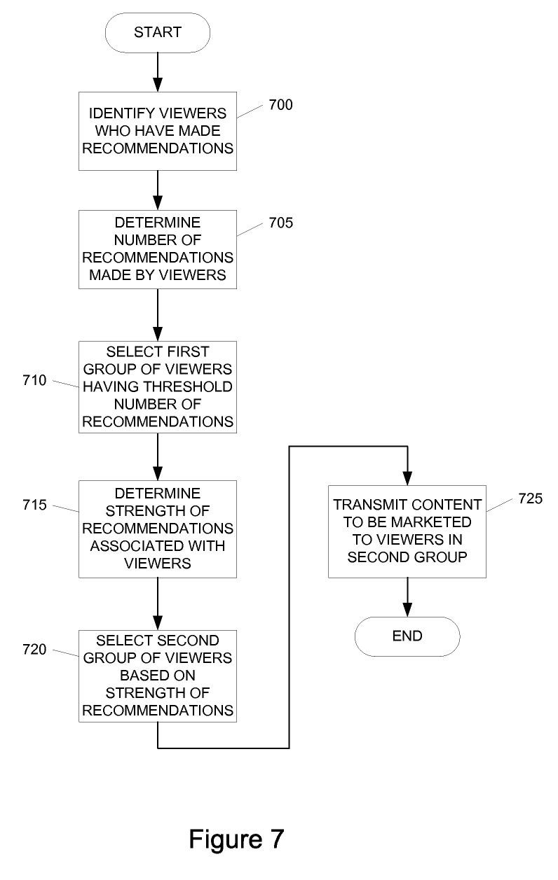

FIG. 7 is a flowchart illustrating a method for identifying a viewer and/or a peer group to which to market programming or advertising content. In step 700, a content provider and/or recommendation service may identify viewers that have made recommendations in the past. The identification process may include extracting viewer information from a database of recommendations maintained by the content provider or recommendation service. In step 705, the content provider and/or recommendation service may determine and evaluate the number of recommendations each identified viewer has made. This information may be relevant in determining the likelihood a recommendation will be made for an advertisement or marketed programming. For example, if a viewer only makes recommendations intermittently, they might not recommend the marketed content even if they are interested. In step 710, a first group of viewers may be selected based on a threshold number of recommendations. Thus, in one example, all viewers having made 10 recommendations in the past week may be selected. In step 715, a further determination and evaluation may be performed to identify the strength of the recommendations made by each viewer in the selected first group of viewers. The strength of recommendations may be determined by analyzing the effect of the recommendations. For example, a content provider may determine a number or percentage of peers that followed a recommendation out of the total number of peers to which the recommendation was sent. One or more of steps 705, 710 and 715 may be optional. For example, a group of viewers to which content is sent may, in one example, be determined without evaluating a number of recommendations viewers have made.

Based on the strength of recommendation analysis, a content provider may select a second group of viewers having a threshold strength of recommendation in step 720. The threshold may be an absolute value (20 people in the last week followed a viewer's recommendation) or may be a percentage (e.g., 50% followed a viewer's recommendation). The threshold may be determined based on the expense involved with marketing the content and the likelihood the marketed content will reach a widespread audience. In one or more arrangements, the second group of viewers may include less than all of the first group of viewers. Alternatively, the second group may include all of the first group of viewers. In step 725, the content provider may transmit the content to be marketed to the selected second group of viewers. The content to be marketed, as discussed, may include a commercial, new programming content, a service announcement and the like.

In one or more configurations, a content provider and/or recommendation service may further consider a viewer's peer group in determining whether to target the viewer and his or her peer group. If, for example, the viewer's peer group does not match the demographic for which the content to be marketed is intended, the content provider might not select the viewer for marketing the content. In another example, if a viewer's peer group is less than a threshold size, a content provider may determine that the expense is too great given the potential viewership.

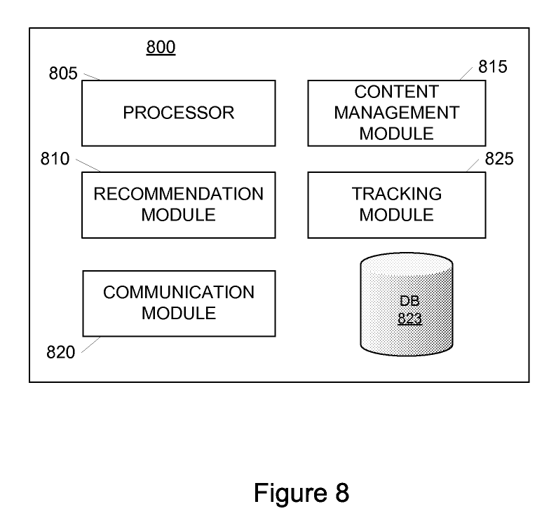

FIG. 8 is a block diagram of a system for determining content to be marketed and identifying viewers to which to market the content. System 800 includes a processor 805, a recommendation module 810, a content management module 815, a communication module 820, database 823 and a tracking module 825. Recommendation module 810 may be configured to collect recommendations and comments from viewers received through communication module 820. Recommendation module 810 may use processor 805 to evaluate and analyze the recommendations received. Content management module 815 may be configured for storing broadcast content and for distributing content to one or more viewers. Content management module 815 may determine the content to distribute with the aid of recommendation module 810. Tracking module 825 may be configured to track viewers' behaviors and correlations between the behaviors and recommendations they have received or made. This allows system 800 to identify the effects of a viewer's recommendation on others. Communications between a viewer and system 800 may be facilitated through communication module 820 which may support a variety of communication protocols. Communication module 820 may provide a downstream channel for transmitting content to viewers as well as an upstream or backward channel for receiving data from the viewers. In one or more configurations, communication module 820 may include a broadcast receiver and a backward channel receiver. Data used or collected by system 800 may be stored in database 823. The system and modules described above may include software, hardware or combinations thereof. One of ordinary skill in the art will appreciate that a variety of other components and modules may be included in system 800.

Additionally, the methods and features recited herein may further be implemented through any number of computer readable mediums that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
providing, via a broadcast transmitter, a recommendation feedback option to a user device for a broadcast program;
receiving, a recommendation for the broadcast program from the user device;
storing the recommendation in association with the broadcast program; and
transmitting the recommendation to one or more other user devices.

2. A method of claim 1, wherein the broadcast transmitted includes a wireless communication transmitter.

3. A method of claim 1, wherein the recommendation feedback option is provided as part of an electronic program guide.

4. A method of claim 1, wherein transmitting the recommendation to one or more other user devices is performed via the broadcast transmitter.

5. A method of claim 1, wherein transmitting the recommendation to one or more other user devices is performed via a wireless communication transmitter.

6. A method of claim 1, wherein the recommendation is transmitted to the one or more other user devices as a part of an electronic program guide.

7. The method of claim 1, wherein the recommendation includes free form comments.

8. The method of claim 1, wherein transmitting the recommendation to one or more other user devices is performed in response to determining that a number of positive recommendations associated with the broadcast program meets a specified threshold.

9. The method of claim 1, wherein the recommendation is received through a backward channel receiver.

10. The method of claim 9, wherein the backward channel receiver includes a wireless communication receiver.

11. The method of claim 1, wherein the one or more other user devices are part of a peer group associated with the user device.

12. The method of claim 1, wherein transmitting the recommendation to one or more other user devices further comprises transmitting the broadcast program to the one or more other user devices.

13. A method comprising:
identifying a number of positive recommendations associated with a program distributed over a broadcast network;
identifying one or more viewers associated with the positive recommendations;
determining a strength of one or more other recommendations received from the identified one or more viewers;
determining to include the program in a broadcast channel lineup based on the number of positive recommendations associated with the program and the strength of the one or more other recommendations received from the identified one or more viewers; and
adding the program to the broadcast channel lineup.

14. The method of claim 13, wherein the strength of the one or more other recommendations corresponds to a number of other viewers receiving the one or more other recommendations who followed the one or more other recommendations.

15. The method of claim 13, wherein determining to include the program in a broadcast channel lineup based on the number of positive recommendations associated with the program and the strength of the one or more other recommendations made by the identified one or more viewers includes determining that the number of positive recommendations meets a threshold number of positive recommendations.

16. The method of 13, wherein the broadcast network comprises a digital video broadcast-handheld (DVB-H) network.

17. The method of claim 13, wherein at least one of the positive recommendations includes free form comments.

18. The method of claim 13, wherein identifying a number of positive recommendations associated with a program distributed over a broadcast network further comprises identifying a number of negative recommendations associated with the program.

19. A method comprising:
identifying one or more broadcast content viewers associated with first received recommendations;
determining a recommendation strength for at least one of the one or more broadcast content viewers, wherein the recommendation strength corresponds to one or more responses to the first received recommendations;
determining whether to send program content to the at least one of the one or more broadcast content viewers based on the determined recommendation strength; and
in response to determining to send the program content to the at least one of the one or more broadcast content viewers, transmitting the program content to a device of the viewer.

20. The method of claim 19, wherein the device of the viewer comprises a mobile telephone.

21. The method of claim 19, wherein the program content is transmitted through a Digital Video Broadcasting-Handheld (DVB-H) network.

22. The method of claim 21, wherein the first received recommendations are received through a backward channel of the DVB-H network.

23. The method of claim 19, further comprising determining whether a number of first received recommendations made by the at least one of the one or more broadcast content viewers meets a threshold number of recommendations.

24. The method of claim 19, wherein the program content comprises an advertisement.

25. A system comprising:
a processor;
a content management module configured to provide a recommendation feedback option to a user device for a broadcast program;
a recommendation module configured to:
receive a recommendation for the program from the user device, and
store the recommendation in association with the broadcast program; and
a communication module configured to transmit the recommendation to one or more other user devices.

26. The system of claim 25, wherein the communication module is configured to transmit the recommendation to the one or more other user devices in response to determining that a number of positive recommendations associated with the program meets a specified threshold.

27. The system of claim 25, wherein the recommendation is received through a backward channel in the broadcast network.

28. A system comprising:
a processor;
a recommendation module configured to:
identify one or more broadcast content viewers associated with received recommendations,
determine a recommendation strength for at least one of the one or more broadcast content viewers, wherein the recommendation strength corresponds to a number of other viewers who followed a first recommendation of the received recommendations provided by the at least one of the one or more broadcast content viewers, and
determine whether to send program content to the at least one of the one or more broadcast content viewers based on the determined recommendation strength; and
a communication module configured to transmit the program content to a device of the viewer in response to determining to send the program content to the at least one of the one or more broadcast content viewers.

29. The system of claim 28, wherein the communication module is configured to transmit the program content through a Digital Video Broadcasting-Handheld (DVB-H) network.

30. The system of claim 28, wherein the received recommendations are received through a backward channel of the DVB-H network.

31. A computer readable medium storing computer readable instructions that, when executed, cause a processor to perform a method comprising:
identifying one or more broadcast content viewers associated with received recommendations;
determining a recommendation strength for at least one of the one or more broadcast content viewers, wherein the recommendation strength corresponds to a number of other viewers who followed a first recommendation of the received recommendations provided by the at least one of the one or more broadcast content viewers;
determining whether to send program content to the at least one of the one or more broadcast content viewers based on the determined recommendation strength; and
in response to determining to send the program content to the at least one of the one or more broadcast content viewers, transmitting the program content to a device of the viewer.

32. The computer readable medium of claim 31, further comprising instructions for determining whether a number of recommendations made by the at least one of the one or more broadcast content viewers meets a threshold number of recommendations.

33. A computer readable medium storing computer readable instructions that, when executed, cause a processor to perform a method comprising:
providing, via a broadcast transmitter, a recommendation feedback option to a user device for a broadcast program;
receiving a recommendation for the program from the user device;
storing the recommendation in association with the program; and
transmitting the recommendation to one or more other user devices.

34. The computer readable medium of claim 33, wherein the recommendation feedback option is provided in an electronic program guide.
